(19) United States
(12) Patent Application Publication
(10) Pub. No.: US 2020/0279000 A1
(43) Pub. Date: Sep. 3, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Takayuki YAMAMOTO, Kanagawa (JP); Yuki TAGAWA, Kanagawa (JP)

(73) Assignee: FUJI XEROX CO., LTD., Tokyo (JP)

(21) Appl. No.: 16/507,016

(22) Filed: Jul. 9, 2019

(30) Foreign Application Priority Data
Feb. 28, 2019 (JP) 2019-035781

(51) Int. Cl. G06F 16/9032; G06F 17/27; G06F 16/903

(52) U.S. Cl. CPC G06F 16/90332; G06F 16/90344; G06F 17/2775; G06F 17/2785

(57) ABSTRACT

An information processing apparatus includes a reception unit that receives an input of a query, a generation unit that generates a word combination from a plurality of words included in the query, an obtaining unit that obtains a node corresponding to each word combination of the query for each word combination of the query from data representing a first node representing a single concept, a second node representing a compound concept, and a relationship between concepts, and a specifying unit that specifies a content corresponding to the node obtained by the obtaining unit.

### CROSS-REFERENCE TO RELATED APPLICATIONS

This application is based on and claims priority under 35 USC 119 from Japanese Patent Application No. 2019-035781 filed Feb. 28, 2019.

### BACKGROUND

### (i) Technical Field

The present invention relates to an information processing apparatus and a non-transitory computer readable medium storing a program.

### (ii) Related Art

For example, JP6075042B discloses a language processing apparatus that generates a relationship between two words by analyzing a sentence. The language processing apparatus includes a phrase determination unit that determines whether or not a phrase including a word and creating one meaning is present for each of plural words based on an analysis result of the meaning of the sentence analyzed by extracting plural words included in the input sentence. In a case where such a phrase is present, the phrase determination unit outputs the phrase. In addition, the language processing apparatus includes an analysis unit that performs morpheme analysis of the sentence, performs sentence structure analysis of the sentence from a relationship between the morphemes of the sentence based on the morpheme analysis, and generates relationship information indicating a semantic relationship between two words relating to each other among the plural words and a semantic relationship between each of the plural words and a word having a principal meaning in the phrase output by the phrase determination unit based on the result of the sentence structure analysis. In addition, the language processing apparatus includes an extension unit that performs a determination as to whether or not to display a word or a phrase as a separate phrase linked to preceding and succeeding words or phrases based on the relationship information in accordance with extension information in which a relationship between the relationship information and whether or not to display the word or the phrase as a separate phrase is predefined. In addition, the language processing apparatus includes a display processing unit that combines the word or the phrase determined to be displayed as a separate phase in one phrase. In addition, the language processing apparatus includes a display unit that displays a word group analyzed as a core concept of the sentence, the phrase combined by the display processing unit, and the relationship information representing a semantic relationship between the word group and the phrase based on the analysis result of the meaning of the sentence and the result of the process in the display processing unit.

In addition, JP5798624B discloses a method of generating a complex knowledge representation. The method includes a step in which a processor receives an input indicating a requested context. In addition, the method includes a step in which the processor applies one or plural rules to an elemental data structure representing at least one elemental concept, at least one elemental concept relationship, or at least one elemental concept and at least one elemental concept relationship. In addition, the method includes a step in which the processor combines one or plural additional concepts, one or plural additional concept relationships, or one or plural additional concepts and one or plural additional concept relationships in accordance with the requested context based on the application of the one or plural rules. In addition, the method includes a step in which the processor generates a complex knowledge representation in accordance with the requested context using at least one additional concept, at least one additional concept relationship, or at least one additional concept and at least one additional concept relationship.

### SUMMARY

Semantic search that outputs a search result by understanding the intent of a user is used as a method of searching for contents such as a document. In the semantic search, contents related to words included in a query are searched using only a node representing a single concept specified from the query. Thus, the intent of the user may not be appropriately reflected on the search result.

Aspects of non-limiting embodiments of the present disclosure relate to an information processing apparatus and a non-transitory computer readable medium storing a program capable of reflecting the intent of a user on a search result more appropriately than a case of searching for contents related to words included in a query using only a node representing a single concept specified from the query.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a reception unit that receives an input of a query, a generation unit that generates a word combination from a plurality of words included in the query, an obtaining unit that obtains a node corresponding to each word combination of the query for each word combination of the query from data representing a first node representing a single concept, a second node representing a compound concept, and a relationship between concepts, and a specifying unit that specifies a content corresponding to the node obtained by the obtaining unit.

### BRIEF DESCRIPTION OF THE DRAWINGS

Exemplary embodiment(s) of the present invention will be described in detail based on the following figures, wherein:

FIG. 1 is a diagram illustrating one example of a configuration of a network system according to an exemplary embodiment;

FIG. 2 is a block diagram illustrating one example of an electrical configuration of an information processing apparatus according to the exemplary embodiment;

FIG. 3 is a block diagram illustrating one example of a functional configuration of the information processing apparatus according to the exemplary embodiment;

FIG. 4 is a diagram for describing a query and a knowledge graph according to the exemplary embodiment;

FIG. 5 is another diagram for describing the query and the knowledge graph according to the exemplary embodiment;

FIG. 6 is a diagram for describing path search and path evaluation according to the exemplary embodiment;

FIG. 7 is a diagram illustrating one example of an importance of a topics node and an importance of a word node according to the exemplary embodiment;

FIG. 8A is a diagram illustrating one example of an abstraction path according to the exemplary embodiment;

FIG. 8B is a diagram illustrating one example of a concretion path according to the exemplary embodiment;

FIG. 8C is a diagram illustrating one example of a mixed path including the abstraction path and the concretion path according to the exemplary embodiment;

FIG. 8D is a diagram illustrating one example of a related path according to the exemplary embodiment;

FIG. 9A is a diagram for describing a score derivation method in the case of the abstraction path according to the exemplary embodiment;

FIG. 9B is a diagram for describing the score derivation method in the case of the concretion path according to the exemplary embodiment;

FIG. 9C is a diagram for describing the score derivation method in the case of the related path according to the exemplary embodiment;

FIG. 10 is a flowchart illustrating one example of a flow of process of a path evaluation processing program according to the exemplary embodiment; and

FIG. 11 is a front view illustrating one example of a search result screen according to the exemplary embodiment.

### DETAILED DESCRIPTION

Hereinafter, one example of an exemplary embodiment of the present invention will be described in detail with reference to the drawings.

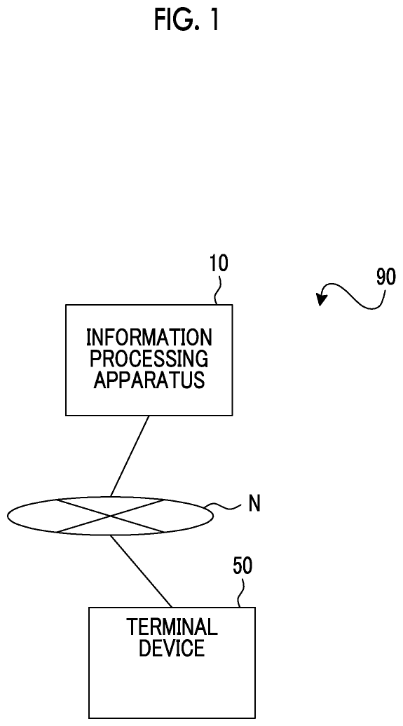

FIG. 1 is a diagram illustrating one example of a configuration of a network system 90 according to the present exemplary embodiment.

As illustrated in FIG. 1, the network system 90 according to the present exemplary embodiment includes an information processing apparatus 10 and a terminal device 50. A general-purpose computer apparatus such as a server computer or a personal computer (PC) is applied to the information processing apparatus 10 according to the present exemplary embodiment.

The information processing apparatus 10 according to the present exemplary embodiment is connected to the terminal device 50 through a network N. For example, the Internet, a local area network (LAN), or a wide area network (WAN) is applied to the network N. A general-purpose computer apparatus such as a personal computer (PC) or a portable computer apparatus such as a smartphone or a tablet terminal is applied to the terminal device 50 according to the present exemplary embodiment.

The information processing apparatus 10 according to the present exemplary embodiment has a semantic search function of obtaining contents related to a query from a search target contents group depending on the query input from the terminal device 50 and ranking and outputting the obtained contents as a search result.

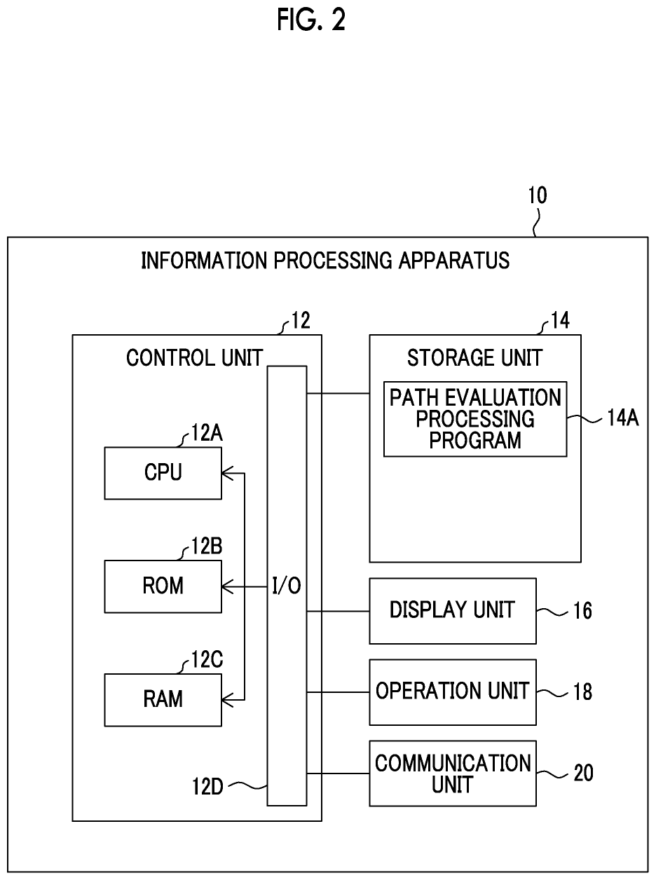

FIG. 2 is a block diagram illustrating one example of an electrical configuration of the information processing apparatus 10 according to the present exemplary embodiment.

As illustrated in FIG. 2, the information processing apparatus 10 according to the present exemplary embodiment includes a control unit 12, a storage unit 14, a display unit 16, an operation unit 18, and a communication unit 20.

The control unit 12 includes a central processing unit (CPU) 12A, a read only memory (ROM) 12B, a random access memory (RAM) 12C, and an input-output interface (I/O) 12D. These units are connected to each other through a bus.

Various function units including the storage unit 14, the display unit 16, the operation unit 18, and the communication unit 20 are connected to the I/O 12D. These function units may communicate with the CPU 12A through the I/O 12D.

The control unit 12 may be configured as a sub-control unit controlling the operation of a part of the information processing apparatus 10 or may be configured as a part of a principal control unit controlling the operation of the whole information processing apparatus 10. An integrated circuit such as large scale integration (LSI) or an integrated circuit (IC) chipset is used in apart or all of the blocks of the control unit 12. Individual circuits may be used in the blocks, or a circuit in which a part or all of the blocks is integrated may be used. The blocks may be disposed as a single unit, or a part of the blocks maybe separately disposed. In addition, in each of the blocks, a part of the block may be separately disposed. The integration of the control unit 12 is not limited to LSI and may use a dedicated circuit or a general-purpose processor.

For example, a hard disk drive (HDD), a solid state drive (SSD), or a flash memory is used as the storage unit 14. The storage unit 14 stores a path evaluation processing program 14A for implementing a path evaluation process according to the present exemplary embodiment. The path evaluation processing program 14A may be stored in the ROM 12B.

For example, the path evaluation processing program 14A may be preinstalled on the information processing apparatus 10. The path evaluation processing program 14A may be implemented such that the path evaluation processing program 14A is stored in a non-volatile storage medium or distributed through the network N and is appropriately installed on the information processing apparatus 10. A compact disc read only memory (CD-ROM), a magneto-optical disc, an HDD, a digital versatile disc read only memory (DVD-ROM), a flash memory, a memory card, or the like is considered as an example of the non-volatile storage medium.

For example, a liquid crystal display (LCD) or an organic electro luminescence (EL) display is used in the display unit 16. The display unit 16 may be integrated with a touch panel.

An operation input device such as a keyboard or a mouse is disposed in the operation unit 18. The display unit 16 and the operation unit 18 receive various instructions from a user of the information processing apparatus 10. The display unit 16 displays various information such as the result of a process executed depending on the instruction received from the user and a notification with respect to the process.

The communication unit 20 is connected to the network N such as the Internet, a LAN, or a WAN and may communicate with the terminal device 50 through the network N.

As described above, in semantic search, contents related to words included in a query are searched using only a node representing a single concept specified from the query. Thus, the intent of the user may not be appropriately reflected on the search result.

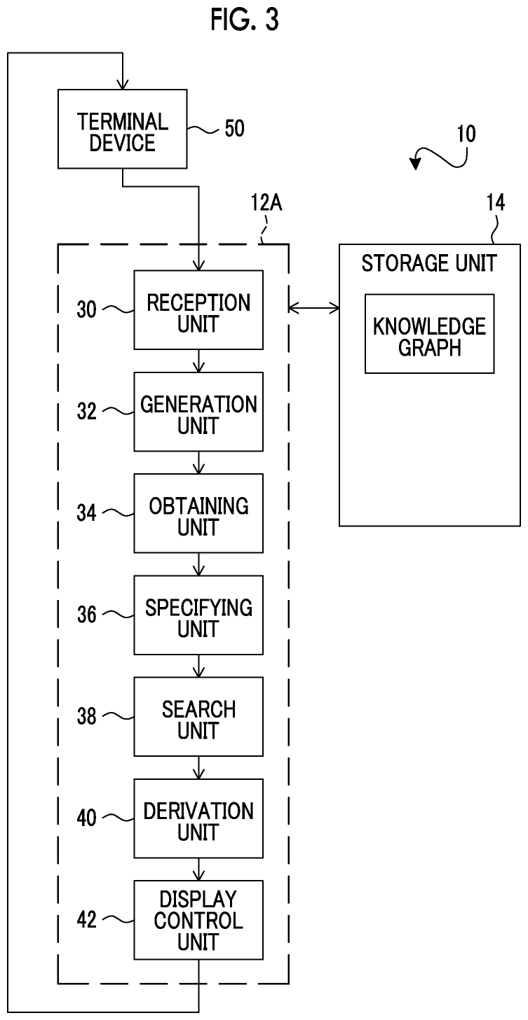

Thus, the CPU 12A of the information processing apparatus 10 according to the present exemplary embodiment functions as each unit illustrated in FIG. 3 by writing the path evaluation processing program 14A stored in the storage unit 14 into the RAM 12C and executing the path evaluation processing program 14A.

FIG. 3 is a block diagram illustrating one example of a functional configuration of the information processing apparatus 10 according to the present exemplary embodiment.

As illustrated in FIG. 3, the CPU 12A of the information processing apparatus 10 according to the present exemplary embodiment functions as a reception unit 30, a generation unit 32, an obtaining unit 34, a specifying unit 36, a search unit 38, a derivation unit 40, and a display control unit 42.

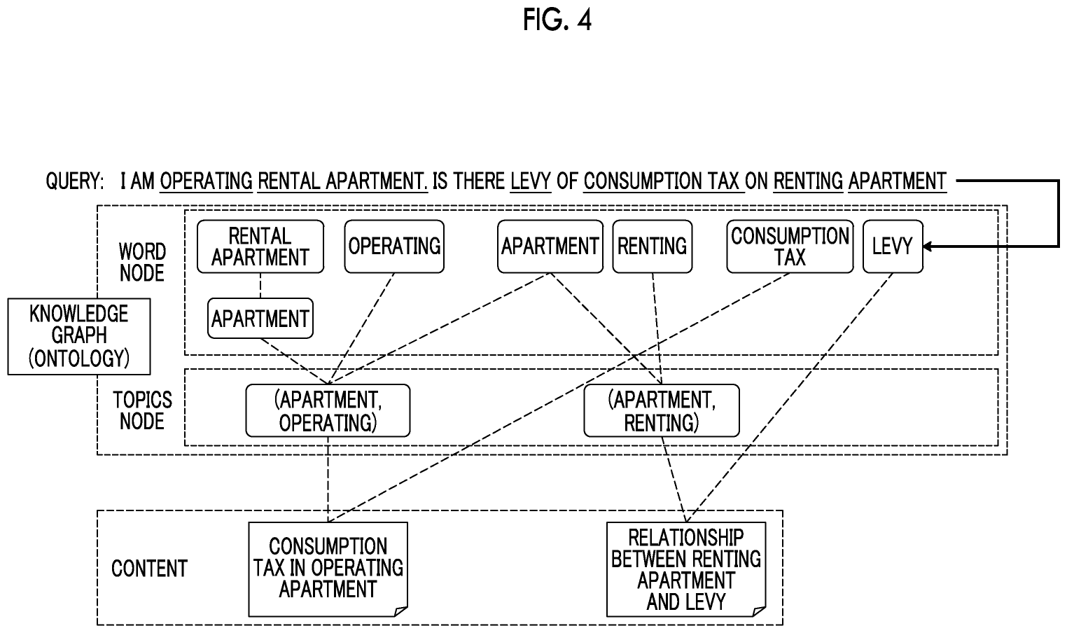

The storage unit 14 according to the present exemplary embodiment stores a knowledge graph. For example, as will be illustrated in FIG. 4 below, the knowledge graph is one example of data including a first node (for example, a word node), a second node (for example, a topics node), and edges. The first node represents a single concept and is connected to one of words included in the input query through an edge. The second node represents a compound concept and is connected to plural first nodes through edges. The edge relates conceptually related nodes to each other among plural nodes representing concepts. The knowledge graph is referred to as an ontology. The knowledge graph is predefined for each search target content and represents concepts in a hierarchical structure. The contents include, for example, a document, an image (including a motion picture), and audio.

The knowledge graph is defined using, for example, the web ontology language (OWL) in the semantic web. For example, a concept (referred to as a “class”) related to the knowledge graph is defined using the resource description framework (RDF) on which the OWL is based. The knowledge graph may be a directed graph or an undirected graph. The presence of an object or a circumstance is represented by assigning a concept representing a physical or virtual presence to each node and connecting a relationship between concepts through an edge having a different label for each type of relationship. Three entities consisting of two concepts (nodes) and a relationship (edge) between both concepts are referred to as a “triple”.

The knowledge graph to be used may include a superordinate or subordinate relationship between concepts and also include information related to a “property” relationship between concepts. The superordinate or subordinate relationship represents a specific relationship such that a superordinate concept includes all entities corresponding to a subordinate concept. Meanwhile, the property relationship represents a freely definable relationship other than the superordinate or subordinate relationship. In addition, a domain and a range are defined in the property. The domain and the range of the property restrict the range of possible values as the starting point and the end point of a relationship between two nodes that may constitute a triple with the property.

The reception unit 30 according to the present exemplary embodiment receives an input of the query from the terminal device 50 used by the user. The query means information input by the user in the case of searching for the contents.

For example, as illustrated in FIG. 4, the generation unit 32 according to the present exemplary embodiment generates a word combination from plural words included in the query.

FIG. 4 is a diagram for describing the query and the knowledge graph according to the present exemplary embodiment.

In the example illustrated in FIG. 4, a query “I am operating rental apartment. Is there levy of consumption tax on renting apartment” is input from the user. The query includes six words of “rental apartment”, “operating”, “apartment”, “renting”, “consumption tax”, and “levy”.

In the example illustrated in FIG. 4, a word combination of the query is a combination of words included in consecutive segments of the query. Specifically, a combination (rental apartment, operating) is generated from “rental apartment” and “operating” included in the consecutive segments of the query. Similarly, a combination (operating, apartment) is generated from “operating” and “apartment”. In addition, a combination (apartment, renting) is generated from “apartment” and “renting”. In addition, a combination (renting, consumption tax) is generated from “renting” and “consumption tax”. In addition, a combination (consumption tax, levy) is generated from “consumption tax” and “levy”. That is, in the example illustrated in FIG. 4, five combinations are generated from the query.

For example, as illustrated in FIG. 4, the obtaining unit 34 according to the present exemplary embodiment obtains anode corresponding to each word combination for each word combination of the query from the knowledge graph stored in the storage unit 14.

The knowledge graph illustrated in FIG. 4 includes six word nodes of “rental apartment”, “operating”, “apartment”, “renting”, “consumption tax”, and “levy”. One or more labels are assigned to the word node. In a case where the label is included in the query, the word node is obtained. The word node to which the label is assigned is assigned “rdfs:label”. In addition, one or more types of relationships are defined between word nodes. Word nodes without a defined relationship are not coupled. In a case where relationships of a superordinate concept and a subordinate concept are present between word nodes, “subClassOf” is assigned between the word nodes. In addition, in a case where a relationship other than the superordinate concept and the subordinate concept is present between word nodes, “relation” is assigned between the word nodes.

In addition, the knowledge graph illustrated in FIG. 4 includes two topics nodes of (apartment, operating) and (apartment, renting). The topics node (apartment, operating) is related in advance to a content “consumption tax in operating apartment”. The topics node (apartment, renting) is related in advance to a content “relationship between renting apartment and levy” . The topics node is also assigned one or more labels in the same manner as the word node. While the topics node obtained by coupling two word nodes is illustratively described in the present exemplary embodiment, the same may be applied to the topics node obtained by coupling three or more word nodes.

As described above, five word combinations (rental apartment, operating), (operating, apartment), (apartment, renting), (renting, consumption tax), and (consumption tax, levy) of the query are present. In a case where the order of words is not considered, the topics node (apartment, operating) is obtained in correspondence with the word combination (operating, apartment) of the query, and the topics node (apartment, renting) is obtained in correspondence with the word combination (apartment, renting) of the query. Since the topics node is a node obtained by combining words, the topics node has higher relevance with the query than the word node does. Accordingly, contents related to the topics node are highly likely to be search results on which the intent of the user is reflected.

The order of words may be considered. In this case, the topics node (apartment, operating) is not obtained in correspondence with the word combination (operating, apartment) of the query, and only the topics node (apartment, renting) corresponding to the word combination (apartment, renting) of the query is obtained. That is, the topics node is obtained in a case where words in the word combinations of the query match the concepts represented by the topics node and the order of words matches the order of concepts. Accordingly, the topics node having higher relevance is obtained.

The obtaining unit 34 may obtain only the topics node or may obtain both of the word node and the topics node. In addition, in a case where a word combination of the query is a specific word combination, only the topics node may be obtained. For example, the query includes the word combination (rental apartment, operating). For the combination (rental apartment, operating), a related word node “apartment” is not obtained, and only the topics node (apartment, operating) is obtained. The specific word means a word of a subordinate concept of the concept of the topics node. Accordingly, the topics node having higher relevance than the word node is obtained.

The specifying unit 36 according to the present exemplary embodiment specifies contents corresponding to the node obtained by the obtaining unit 34. In the example illustrated in FIG. 4, the content (consumption tax in operating apartment” corresponding to the topics node (apartment, operating) is specified, and the content “relationship between renting apartment and levy” corresponding to the topics node (apartment, renting) is specified.

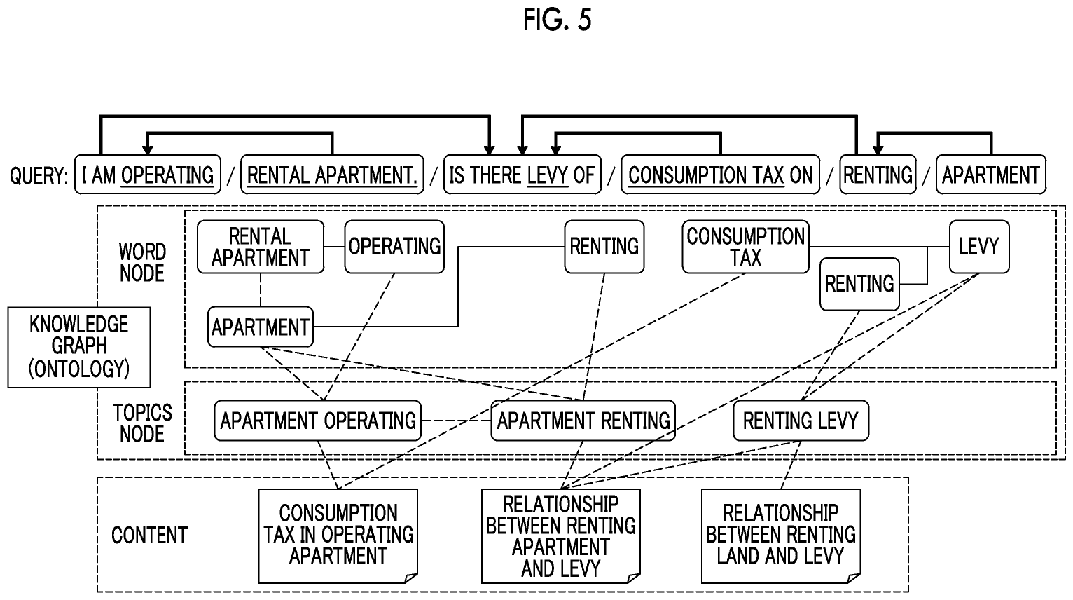

Next, a case where a word combination of the query is a word combination included in segments having a dependency relationship in the query will be described with reference to FIG. 5.

FIG. 5 is another diagram for describing the query and the knowledge graph according to the present exemplary embodiment.

In the example illustrated in FIG. 5, the query “I am operating rental apartment. Is there levy of consumption tax on renting apartment” is input from the user in the same manner as the example illustrated in FIG. 4. The query includes six words of “rental apartment”, “operating”, “apartment”, “renting”, “consumption tax”, and “levy”.

In the example illustrated in FIG. 5, a word combination of the query is a combination of words included in segments having a dependency relationship in the query. Specifically, the combination (rental apartment, operating) is generated from “rental apartment” and “operating” included in the segments having a dependency relationship in the query. Similarly, a combination (operating, levy) is generated from “operating” and “levy”. In addition, the combination (apartment, renting) is generated from “apartment” and “renting”. In addition, a combination (renting, levy) is generated from “renting” and “levy”. In addition, the combination (consumption tax, levy) is generated from “consumption tax” and “levy”. That is, in the example illustrated in FIG. 5, five combinations are generated from the query. For example, the dependency relationship is analyzed using a Japanese dependency analyzer referred to as CaboCha.

For example, as illustrated in FIG. 5, the obtaining unit 34 obtains a node corresponding to each word combination for each word combination of the query from the knowledge graph stored in the storage unit 14. For example, the topics node is obtained in a case where words in the word combinations of the query match the concepts represented by the topics node. The topics nodes may be related to each other. In the example illustrated in FIG. 5, the topics node (apartment, operating) is related to the topics node (apartment, renting).

The knowledge graph illustrated in FIG. 5 includes three topics nodes of (apartment, operating), (apartment, renting), and (renting, levy). The topics node (apartment, operating) is related in advance to the content “consumption tax in operating apartment”. The topics node (apartment, renting) is related in advance to the content “relationship between renting apartment and levy”. The topics node (renting, levy) is related in advance to a content “relationship between renting land and levy”. As described above, five word combinations (rental apartment, operating), (operating, levy), (apartment, renting), (renting, levy), and (consumption tax, levy) of the query are present. The topics node (apartment, operating) is obtained in correspondence with the word combination (rental apartment, operating) of the query. The topics node (apartment, operating) is obtained because “rental apartment” and “apartment” are related nodes. Similarly, the topics node (apartment, renting) is obtained in correspondence with the word combination (apartment, renting) of the query, and the topics node (renting, levy) is obtained in correspondence with the word combination (renting, levy) of the query.

The specifying unit 36 specifies contents corresponding to the node obtained by the obtaining unit 34. In the example illustrated in FIG. 5, the content “consumption tax in operating apartment” corresponding to the topics node (apartment, operating) is specified. The content “relationship between renting apartment and levy” corresponding to the topics node (apartment, renting) is specified. The content “relationship between renting land and levy” corresponding to the topics node (renting, levy) is specified.

The search unit 38 according to the present exemplary embodiment searches for a path including nodes related to each other through an edge from plural nodes corresponding to the contents specified by the specifying unit 36. For example, the search for the path uses a well-known algorithm for the shortest path problem. The shortest path problem is an optimization problem for obtaining a path having a smallest weight among paths connecting two nodes given in a weighted graph. For example, the Dijkstra method, the Bellman-Ford method, or the Warshall-Floyd method is used as the algorithm for the shortest path problem.

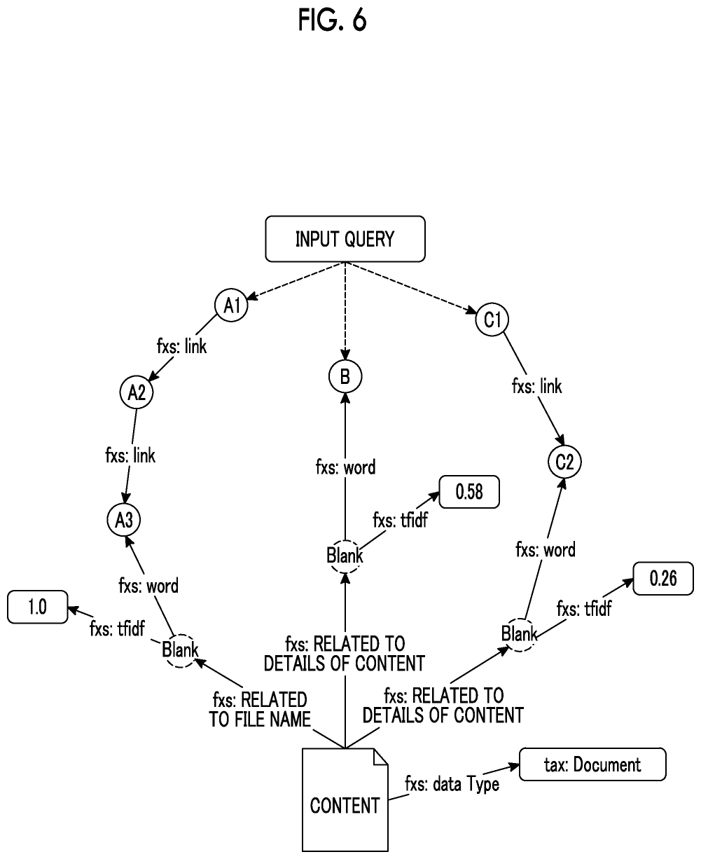

For example, as illustrated in FIG. 6, the derivation unit 40 according to the present exemplary embodiment derives a score for at least one path of the content searched by the search unit 38. The score is derived using at least one of the number of hops, the importance of the concept in the content, or the type of relationship between concepts. The number of hops is represented by the number of nodes or the number of edges included between the node representing the concept included in the query and the content. The concept included in the query means a word or a word combination included in the query. In a case where plural paths are present, the derivation unit 40 derives the score corresponding to each of the plural paths and derives the score of the content by totaling the derived scores.

FIG. 6 is a diagram for describing path search and path evaluation according to the present exemplary embodiment.

In the example illustrated in FIG. 6, three paths of a first path to a third path are searched from a knowledge graph of a certain content in response to the input query. The first path is a path including concept nodes A1, A2, and A3. The second path is a path including a concept node B. The third path is a path including concept nodes C1 and C2. The concept node means the word node or the topics node.

In FIG. 6, the concept node A1 is a concept included in the query, and the concept node A3 is a concept included in the content. The concept node B is a concept included in both of the query and the content. The concept node C1 is a concept included in the query, and the concept node C2 is a concept included in the content. The presence of a link between concept nodes is denoted by “fxs:link”. In addition, “fxs:word” denotes that the word included in the content corresponds to the concept node. In addition, “fxs:tfidf” denotes that the importance of the concept in the content is set. In addition, “fxs:related to file name” denotes that the concept node is related to a file name of the content. In addition, “fxs:related to details of content” denotes that the concept node is related to the details of the content. In addition, “fxs:dataType” denotes a data type of the content.

The importance of the concept node in the content is set between the concept node (in the example illustrated in FIG. 6, the concept nodes A3, B, and C2) corresponding to the word or the word combination included in the content and the content. For example, the importance is calculated using the term frequency (TF)-inverse document frequency (IDF) method. TF denotes the frequency of occurrence of a concept (or a word), and IDF denotes the inverse document frequency. The importance is represented as the product (TF*IDF) of TF and IDF. TF is increased as the frequency of occurrence of a specific word in a certain document is increased, and IDF is decreased as the specific word is a word frequently occurring in other documents. Thus, TF*IDF is an indicator representing that a certain word is a word distinguishing the document. As described above, plural language surfaces may be assigned as labels to the concept node of the knowledge graph. Thus, TF*IDF is calculated in units of concepts and not word surfaces.

For example, an importance Tᵢⱼ of a concept node tᵢ in a document j is calculated using Expression (1) below. The number of occurrence of the language surface assigned to the concept node tᵢ in the document j is denoted by nᵢⱼ. The number of occurrence of the language surface assigned to all concept nodes in the document j is denoted by Σₖnₖⱼ. The number of search target documents is denoted by |D|. The number of documents including the concept node tᵢ is denoted by |{d:d∃tᵢ}|.

$${T}_{ij} = \frac{{n}_{ij}}{{\sum }_{k} {n}_{kj}} \cdot ( log \frac{1 + \vert D \vert}{1 + \vert \{ d \text{:} d ∋ {t}_{i} \} \vert} + 1 ) \qquad ( 1 )$$

A score Sⱼ with respect to the content, for example, is calculated using Expression (2) below using a number d of hops and the importance Tᵢⱼ. The number of paths is denoted by R. Score adjustment parameters (constants) are denoted by kₜ and k_{d}.

$${S}_{j} = {\sum }_{R} \frac{{T}_{ij} + {k}_{t}}{d + {k}_{d}} \qquad ( 2 )$$

Specifically, in the case of the first path illustrated in FIG. 6, the number d of hops is equal to 2. The importance Tᵢⱼ is equal to 1.0. The parameter kₜ is equal to 1, and the parameter k_{d} is equal to 1. Thus, a score S₁ of the first path is calculated as S₁=(1.0+1)/(2+1)≈0.67. Similarly, in the case of the second path, the number d of hops is equal to 0. The importance Tᵢⱼ is equal to 0.58. The parameter kₜ is equal to 1, and the parameter k_{d} is equal to 1. Thus, a score S₂ of the second path is calculated as S₂=(0.58+1)/(0+1)=1.58. In the case of the third path, the number d of hops is equal to 1. The importance Tᵢⱼ is equal to 0.26. The parameter kₜ is equal to 1, and the parameter k_{d} is equal to 1. Thus, a score S₃ of the third path is calculated as S₃=(0.26+1)/(1+1)=0.63. Accordingly, the score Sⱼ of the content is calculated as Sⱼ=S₁+S₂+S₃=0.67+1.58+0.63=2.88 points. In the case of using Expression (2), the calculated score of the content is increased as the number of hops per path is decreased and the number of paths included in the content is increased. That is, a content having a small number of hops and a large number of paths is highly likely to be a search result on which the intent of the user is reflected.

In addition, for example, the upper limit of the number of hops may be specified by the user. As the upper limit of the number of hops is decreased, noise is reduced, but the number of paths is also reduced. As the upper limit of the number of hops is increased, the number of paths is increased, but the noise is also increased. That is, in a case where the user desires to prioritize the reduction of the noise, the user may specify the upper limit of the number of hops to a small number. In a case where the user desires to prioritize the increase of the number of paths, the user may specify the upper limit of the number of hops to a large number. In addition, in a case where the user desires to secure a certain number of paths while reducing the noise, the user may specify the upper limit of the number of hops between a small number and a large number.

While the above example uses the number of hops and the importance in the derivation of the score with respect to the path, the example is not for limitation purposes. The score with respect to the path may be derived using only the number of hops. The score with respect to the path may be derived using only the importance.

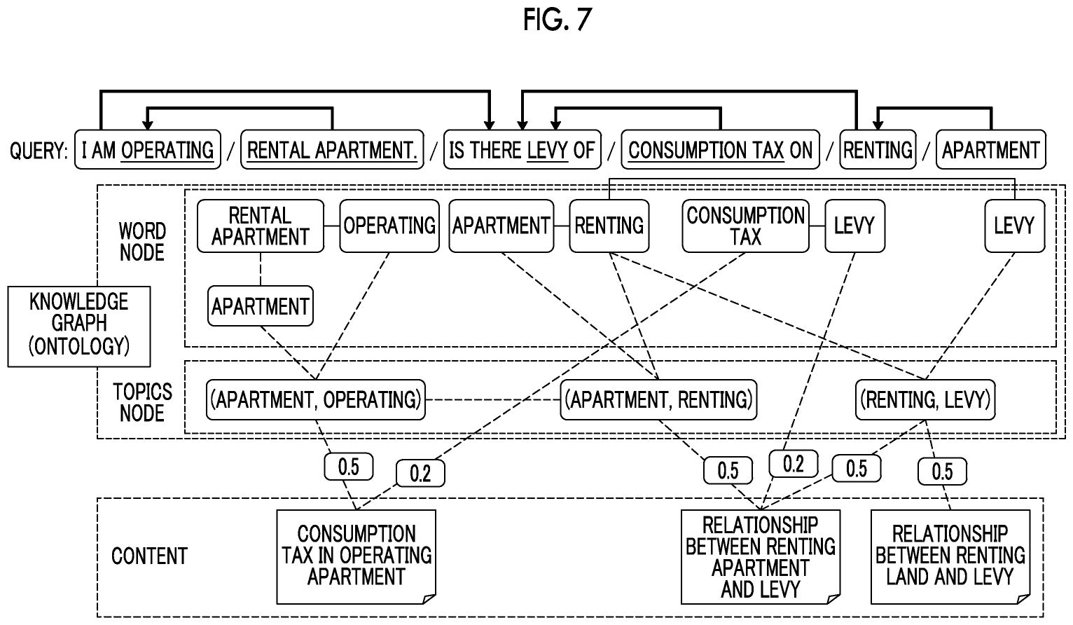

For example, as illustrated in FIG. 7, the importance of the concept represented by the topics node is calculated to be higher than the importance of the concept represented by the word node.

FIG. 7 is a diagram illustrating one example of the importance of the topics node and the importance of the word node according to the present exemplary embodiment.

In the example illustrated in FIG. 7, the importance of the topics node is calculated as 0.5, and the importance of the word node is calculated as 0.2. Accordingly, a content having a large number of topics nodes has a high score and is highly likely to be a search result on which the intent of the user is reflected.

In addition, the importance of the concept represented by the topics node in a path including the word node may be calculated to be lower than the importance of the concept represented by the topics node in a path not including the word node. Specifically, in the example illustrated in FIG. 7, in a case where a path reaching the topics node (apartment, operating) from a word node “rental apartment” through the word node “apartment” and a path directly reaching the topics node (apartment, operating) from the word node “rental apartment” are considered, the importance of the topics node (apartment, operating) in the path including the word node “apartment” is calculated to be lower than the importance of the topics node (apartment, operating) in the path not including the word node “apartment”. Accordingly, a content including a path directly reaching the topics node without passing through the word node has a high score and is highly likely to be a search result on which the intent of the user is reflected.

In addition, the importance of the concept represented by the topics node obtained in correspondence with a word repeatedly included in the query may be calculated to be higher than the importance of the concept represented by the topics node obtained in correspondence with a word included only once in the query. Specifically, in the example illustrated in FIG. 7, the word “apartment” is repeatedly included in the query. Thus, the importance of the topics node (apartment, operating) or the topics node (apartment, renting) is calculated to be higher than the importance of the topics node (renting, levy).

Next, a case where the path search is performed considering the type of relationship between concepts will be described. The type of relationship between concepts includes a first type indicating the relationships of the superordinate concept and the subordinate concept and a second type indicating a relationship other than the superordinate concept and the subordinate concept. In the present exemplary embodiment, the first type is represented as “subClassOf”, and the second type is represented as “relation”.

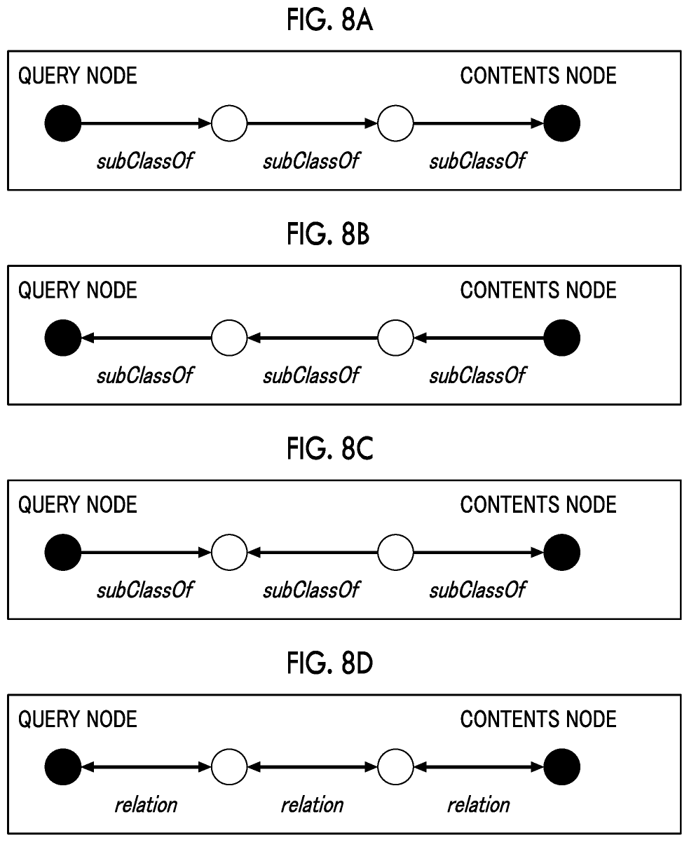

FIG. 8A is a diagram illustrating one example of an abstraction path according to the present exemplary embodiment.

The abstraction path illustrated in FIG. 8A is a path in which “subClassOf” is included and the topics node (referred to as a “contents node”) on the contents side is a superordinate concept of the word node (referred to as a “query node”) on the query side. A black circle at the right end of FIG. 8A denotes the query node. A black circle at the left end of FIG. 8A denotes the contents node. The direction of arrows in FIG. 8A denotes a direction from the subordinate concept to the superordinate concept.

FIG. 8B is a diagram illustrating one example of a concretion path according to the present exemplary embodiment.

The concretion path illustrated in FIG. 8B is a path in which “subClassOf” is included and the contents node is a subordinate concept of the query node.

FIG. 8C is a diagram illustrating one example of a mixed path including the abstraction path and the concretion path according to the present exemplary embodiment.

The mixed path illustrated in FIG. 8C is a path including “subClassOf” and both of the abstraction path and the concretion path.

FIG. 8D is a diagram illustrating one example of a related path according to the present exemplary embodiment.

The related path illustrated in FIG. 8D is a path including “relation”.

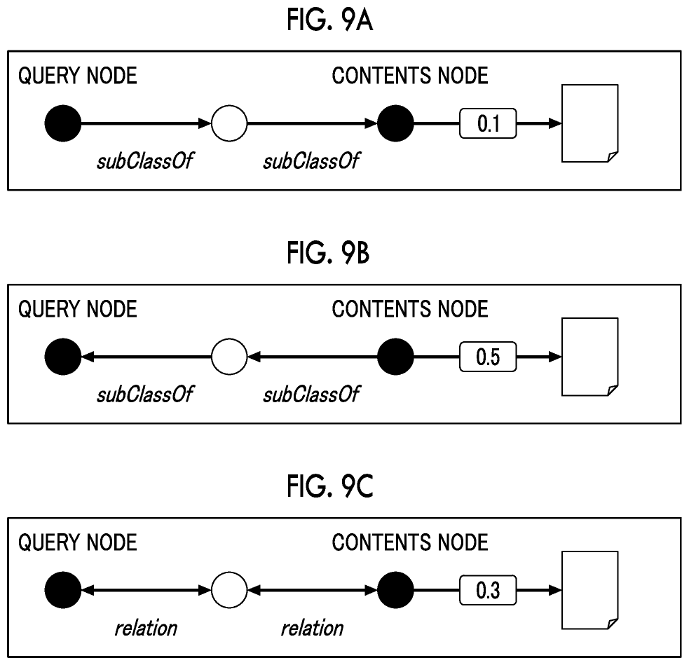

Next, a case where the derivation of the score is performed considering the type of relationship between concepts will be described. In this case, for example, as illustrated in FIG. 9A to FIG. 9C, the importance of the concept represented by the contents node (topics node) is set to vary among the abstraction path, the concretion path, and the related path. The score of each path is calculated using Expression (2).

FIG. 9A is a diagram for describing a score derivation method in the case of the abstraction path according to the present exemplary embodiment.

In the abstraction path illustrated in FIG. 9A, for example, the number d of hops is equal to 2. The importance Tᵢⱼ is equal to 0.1. The parameter kₜ is equal to 1, and the parameter k_{d} is equal to 1. Thus, a score S of the abstraction path is calculated as S=(0.1+1)/(2+1)≈0.37 using Expression (2).

FIG. 9B is a diagram for describing the score derivation method in the case of the concretion path according to the present exemplary embodiment.

In the concretion path illustrated in FIG. 9B, for example, the number d of hops is equal to 2. The importance Tᵢⱼ is equal to 0.5. The parameter kₜ is equal to 1, and the parameter k_{d} is equal to 1. Thus, the score S of the concretion path is calculated as S=(0.5+1)/(2+1)=0.5 using Expression (2).

FIG. 9C is a diagram for describing the score derivation method in the case of the related path according to the present exemplary embodiment.

In the related path illustrated in FIG. 9C, for example, the number d of hops is equal to 2. The importance Tᵢⱼ is equal to 0.3. The parameter kₜ is equal to 1, and the parameter k_{d} is equal to 1. Thus, the score S of the related path is calculated as S=(0.3+1)/(2+1)≈0.43 using Expression (2).

That is, the importance of the concept represented by the topics node in the abstraction path including “subClassOf” and illustrated in FIG. 9A is calculated to be lower than the importance of the concept represented by the topics node in the related path including “relation” and illustrated in FIG. 9C. In addition, the importance of the concept represented by the topics node in the concretion path including “subClassOf” and illustrated in FIG. 9B is calculated to be higher than the importance of the concept represented by the topics node in the related path including “relation” and illustrated in FIG. 9C.

In a case where the number of hops is excessively increased, a process load is increased. Thus, for example, a restriction is desirably imposed on the total number of hops per path regardless of the relationship.

The derivation unit 40 generates a contents list by ranking the contents in descending order of score based on the score of each content derived as described above.

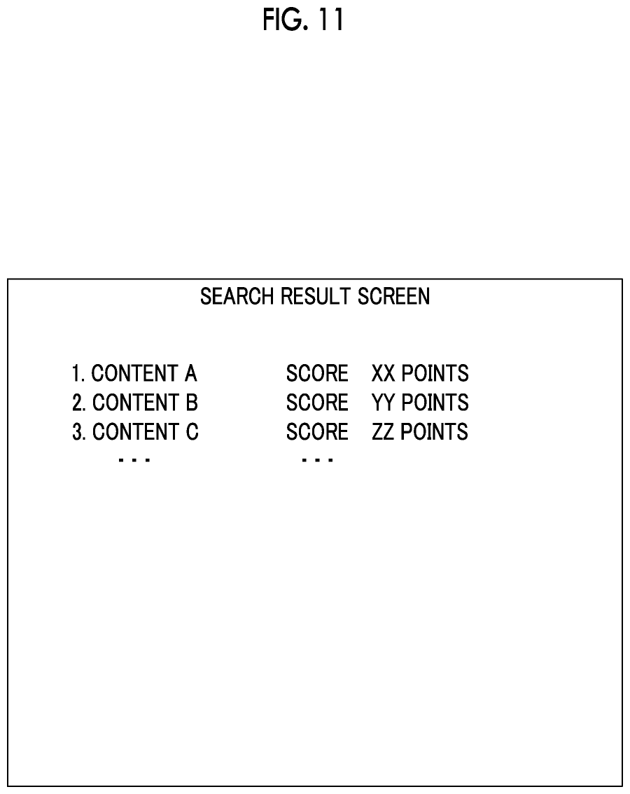

For example, the display control unit 42 according to the present exemplary embodiment performs control for displaying the contents list generated by the derivation unit on the terminal device 50 as a search result screen illustrated in FIG. 11 below.

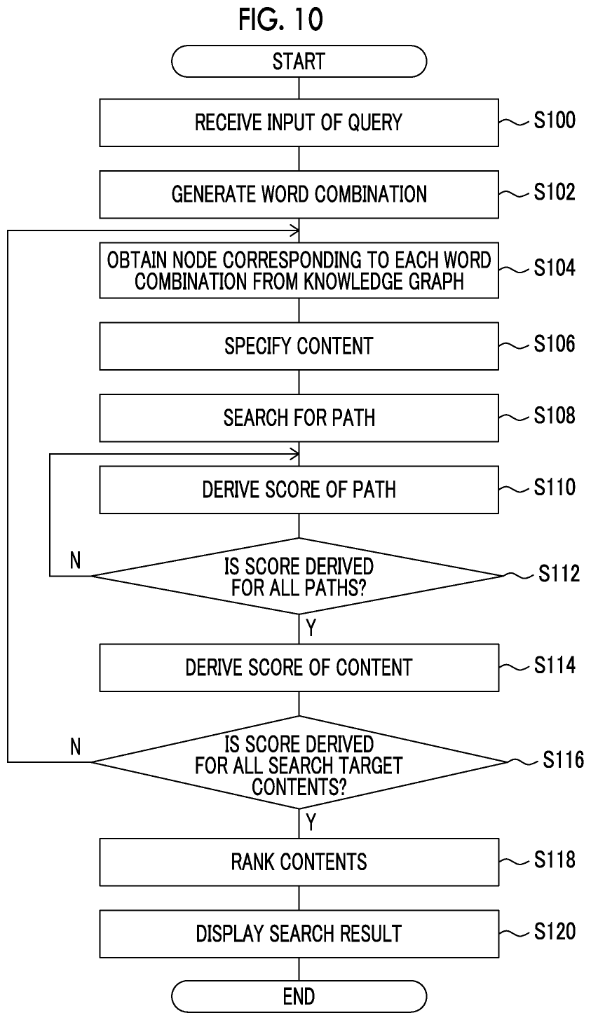

Next, the operation of the information processing apparatus 10 according to the present exemplary embodiment will be described with reference to FIG. 10.

FIG. 10 is a flowchart illustrating one example of a flow of process of the path evaluation processing program 14A according to the present exemplary embodiment.

First, in a case where an instruction to start the path evaluation processing program 14A is provided to the information processing apparatus 10, each of the following steps is executed.

In step 100 in FIG. 10, for example, the reception unit 30 receives an input of the query illustrated in FIG. 4 or FIG. 5 from the terminal device 50 used by the user.

In step 102, for example, as illustrated in FIG. 4 or FIG. 5, the generation unit 32 generates a word combination from plural words included in the query.

In step 104, for example, the obtaining unit 34 obtains a node corresponding to each word combination for each word combination of the query from the knowledge graph illustrated in FIG. 4 or FIG. 5.

In step 106, for example, as illustrated in FIG. 4 or FIG. 5, the specifying unit 36 specifies a content corresponding to the node obtained in step 104.

In step 108, for example, as illustrated in FIG. 6, the search unit 38 searches for a path including nodes related to each other through an edge from plural nodes corresponding to the content specified in step 106.

In step 110, the derivation unit 40 derives a score using at least one of the number of hops, the importance of the concept in the content, or the type of relationship between concepts with respect to the path searched in step 108. For example, the score is derived using Expression (1) and Expression (2).

In step 112, the derivation unit 40 determines whether or not the score is derived for all paths of the content. In a case where it is determined that the score is derived for all paths of the content (in the case of a positive determination), a transition is made to step 114. In a case where it is determined that the score is not derived for all paths of the content (in the case of a negative determination), a return is made to step 110, and the process is repeated.

In step 114, for example, the derivation unit 40 derives the score of the content using Expression (2).

In step 116, the derivation unit 40 determines whether or not the score is derived for all search target contents. In a case where it is determined that the score is derived for all search target contents (in the case of a positive determination), a transition is made to step 118. In a case where it is determined that the score is not derived for all search target contents (in the case of a negative determination), a return is made to step 104, and the process is repeated.

In step 118, the derivation unit 40 generates the contents list by ranking the contents in descending order of score based on the score of each content derived in step 114.

In step 120, for example, the display control unit 42 performs control for displaying the contents list generated instep 118 on the terminal device 50 as the search result screen illustrated in FIG. 11. The series of processes of the path evaluation processing program 14A is finished.

FIG. 11 is a front view illustrating one example of the search result screen according to the present exemplary embodiment.

The search result screen illustrated in FIG. 11 is a screen of the content list in which plural contents obtained as the search result are ranked in descending order of score. The search result screen is displayed on the terminal device 50.

According to the present exemplary embodiment, contents related to words included in the query is searched using the topics node representing a compound concept specified from the query. Accordingly, the user may obtain the search result on which the intent of the user is reflected.

The information processing apparatus according to the exemplary embodiment is illustratively described thus far. The exemplary embodiment may be in the form of program for causing a computer to execute the function of each unit included in the information processing apparatus. The exemplary embodiment may be in the form of computer readable storage medium storing the program.

Besides, the configuration of the information processing apparatus described in the exemplary embodiment is for illustrative purposes and may be modified without departing from the gist thereof depending on the circumstances.

In addition, the flow of process of the program described in the exemplary embodiment is for illustrative purposes and may be subjected to removal of unnecessary steps, addition of new steps, and change of the process order without departing from the gist thereof.

In addition, while a case where the process according to the exemplary embodiment is implemented based on a software configuration by executing the program using the computer is described in the exemplary embodiment, the case is not for limitation purposes. For example, the exemplary embodiment may be implemented using a hardware configuration or a combination of a hardware configuration and a software configuration.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a reception unit that receives an input of a query;
a generation unit that generates a word combination from a plurality of words included in the query;
an obtaining unit that obtains a node corresponding to each word combination of the query for each word combination of the query from data representing a first node representing a single concept, a second node representing a compound concept, and a relationship between concepts; and
a specifying unit that specifies a content corresponding to the node obtained by the obtaining unit.

2. The information processing apparatus according to claim 1,
wherein the word combination of the query is a combination of words included in consecutive segments of the query.

3. The information processing apparatus according to claim 2,
wherein in a case where words in the word combination of the query match concepts represented by the second node and an order of the words matches an order of the concepts, the obtaining unit obtains the second node.

4. The information processing apparatus according to claim 2,
wherein in a case where the word combination of the query is a specific word combination, the obtaining unit obtains only the second node.

5. The information processing apparatus according to claim 3,
wherein in a case where the word combination of the query is a specific word combination, the obtaining unit obtains only the second node.

6. The information processing apparatus according to claim 1,
wherein the word combination of the query is a combination of words included in segments of the query having a dependency relationship.

7. The information processing apparatus according to claim 6,
wherein in a case where words in the word combination of the query match concepts represented by the second node, the obtaining unit obtains the second node.

8. The information processing apparatus according to claim 1, further comprising:
a search unit that searches for a path including nodes related to each other from a plurality of nodes corresponding to the content specified by the specifying unit; and
a derivation unit that derives a score using at least one of the number of hops represented as the number of nodes included between a node representing a concept included in the query and the content, an importance of a concept in the content, or a type of relationship between concepts for at least one path of the content searched by the search unit.

9. The information processing apparatus according to claim 2, further comprising:
a search unit that searches for a path including nodes related to each other from a plurality of nodes corresponding to the content specified by the specifying unit; and
a derivation unit that derives a score using at least one of the number of hops represented as the number of nodes included between a node representing a concept included in the query and the content, an importance of a concept in the content, or a type of relationship between concepts for at least one path of the content searched by the search unit.

10. The information processing apparatus according to claim 3, further comprising:
a search unit that searches for a path including nodes related to each other from a plurality of nodes corresponding to the content specified by the specifying unit; and
a derivation unit that derives a score using at least one of the number of hops represented as the number of nodes included between a node representing a concept included in the query and the content, an importance of a concept in the content, or a type of relationship between concepts for at least one path of the content searched by the search unit.

11. The information processing apparatus according to claim 4, further comprising:
a search unit that searches for a path including nodes related to each other from a plurality of nodes corresponding to the content specified by the specifying unit; and
a derivation unit that derives a score using at least one of the number of hops represented as the number of nodes included between a node representing a concept included in the query and the content, an importance of a concept in the content, or a type of relationship between concepts for at least one path of the content searched by the search unit.

12. The information processing apparatus according to claim 5, further comprising:
a search unit that searches for a path including nodes related to each other from a plurality of nodes corresponding to the content specified by the specifying unit; and
a derivation unit that derives a score using at least one of the number of hops represented as the number of nodes included between a node representing a concept included in the query and the content, an importance of a concept in the content, or a type of relationship between concepts for at least one path of the content searched by the search unit.

13. The information processing apparatus according to claim 8,
wherein in a case where a plurality of the paths are present, the derivation unit derives the score for each of the plurality of paths and derives a score of the content by totaling the derived scores.

14. The information processing apparatus according to claim 8,
wherein the importance of the concept is calculated using a TF-IDF method.

15. The information processing apparatus according to claim 8,
wherein an importance of a concept represented by the second node is calculated to be higher than an importance of a concept represented by the first node.

16. The information processing apparatus according to claim 15,
wherein the importance of the concept represented by the second node in a path including the first node is calculated to be lower than the importance of the concept represented by the second node in a path not including the first node.

17. The information processing apparatus according to claim 15,
wherein the importance of the concept represented by the second node obtained in correspondence with a word repeatedly included in the query is calculated to be higher than the importance of the concept represented by the second node obtained in correspondence with a word included only once in the query.

18. The information processing apparatus according to claim 8,
wherein the type of relationship between concepts includes a first type indicating relationships of a superordinate concept and a subordinate concept and a second type indicating a relationship other than the superordinate concept and the subordinate concept, and
an importance of a concept represented by the second node varies among an abstraction path in which the first type of relationship is included and a concept on the contents side is a superordinate concept of a concept on the query side, a concretion path in which the first type of relationship is included and the concept on the contents side is a subordinate concept of the concept on the query side, and a related path including the second type of relationship.

19. The information processing apparatus according to claim 18,
wherein the importance of the concept represented by the second node in the abstraction path is calculated to be lower than the importance of the concept represented by the second node in the related path, and
the importance of the concept represented by the second node in the concretion path is calculated to be higher than the importance of the concept represented by the second node in the related path.

20. A non-transitory computer readable medium storing a program causing a computer to function as each unit included in the information processing apparatus according to claim 1.
